(19) United States
(12) Patent Application Publication
(10) Pub. No.: US 2025/0311762 A1
(43) Pub. Date: Oct. 9, 2025

(54) FORMULATION AND METHOD FOR AN EXERCISE SUPPORTING NUTRITIONAL SUPPLEMENT

(71) Applicant: BullFit, LLC., Idaho Falls, ID (US)

(72) Inventors: HARRISON MITCHELL, Idaho Falls, ID (US); BEN WILKINSON, Sandy, UT (US); JOSH GRAVES, South Jordan, UT (US)

(73) Assignee: BullFit, LLC., Idaho Falls, ID (US)

(21) Appl. No.: 19/174,744

(22) Filed: Apr. 9, 2025

Related U.S. Application Data
(60) Provisional application No. 63/631,864, filed on Apr. 9, 2024.

(51) Int. Cl. A23L 33/175; A23L 29/00; A23L 29/281; A23L 33/105; A23L 33/16

(52) U.S. Cl. CPC A23L 33/175; A23L 29/045; A23L 29/284; A23L 33/105; A23L 33/16

(57) ABSTRACT

Provided herein is an exercise supporting nutritional supplement with an associated delivery platform, method, and system. As disclosed the exercise supporting nutritional supplement may comprise some or all of Agmatine Sulfate, Betaine Anhydrous, Choline (as Choline Bitartrate), Citrulline, Creatine Monohydrate, Beta Alanine, L-Tyrosine, Choline Bitartrate, Bovine Collagen, Caffeine Anhydrous, Pink Himalayan Salt, and Black Pepper Extract.

### FIELD

This invention relates to nutritional supplements and more particularly relates to a formulation for a pre and post workout strengthening and replenishing supplement.

### BACKGROUND

The present formulation features novel dietary supplements which may benefit individuals preparing for, engaging in, and/or recovering from exercise. Exercise can generate free radicals and can deplete specific nutrients essential for energy production, muscle contraction, electrolyte balance, and recovery. Existing supplements principally rely on plant and other extracts that are not identical to and are even sometimes incompatible with the nutrient end products and intrinsic molecules of a mammalian and human biological system. Therefore, a need exists for a formulation that would supply precursors, end products and compatible intrinsic molecules. Beneficially such a formulation would comprise or facilitate the nutrient end products and natural biological molecules in a form and configuration easily accessible to a mammalian and human biological system.

### SUMMARY

The present invention has been developed in response to the present state of the art, and in particular, in response to the problems and needs in the art that have not yet been fully solved by currently available exercise supplements. Accordingly, the present supplement has been developed to provide a formulation that overcomes many or all of the above-discussed shortcomings in the art.

The content of this patent application is presented solely for the purpose of being reviewed by the United States Patent and Trademark Office for patentability of the claimed novel exercise and dietary supplement, in accordance with the Dietary Supplement Health and Education Act of 1994 (DSHEA). Applicants assert that statements made within this patent application have not been evaluated by the Food and Drug Administration and that the novel combination of constituents in the recited supplement is not intended to diagnose, treat, prevent, mitigate, or cure disease.

Provided herein is a formulation for an exercise supporting nutritional supplement, in some embodiments the formulation comprising; L-Citrulline, Agmatine Sulfate, and Betaine Anhydrous. The formulation may further comprise at least one of β Alanine, Creatine monohydrate, or L-Tyrosine. The formulation sometimes comprises at least one of Bovine Collagen or Pink Himalayan Salt. In certain embodiments the formulation comprises at least one of Caffeine Anhydrous, Black Pepper Extract, Choline Bitartrate, or Allulose.

In various embodiments the formulation comprises L-Citrulline, Agmatine Sulfate, Betaine Anhydrous, β Alanine, Creatine monohydrate, L-Tyrosine, Bovine Collagen, Pink Himalayan Salt, Caffeine Anhydrous, Black Pepper Extract, Choline Bitartrate, and Allulose.

The formulation may comprise one or more of Choline (as Choline Bitartrate) in a range of 50 mg to 200 mg including 166 mg, Citrulline in a range of 1000 mg to 5000 mg including 4000 mg, Beta Alanine in a range of 500 mg to 3000 mg including 1600 mg, Creatine Monohydrate in a range of 100 mg to 3000 mg including 1000 mg, L-Tyrosine in a range of 300 mg to 1500 mg including 750 mg, Bovine Collagen in a range of 100 mg to 1000 mg including 500 mg, Choline Bitartrate in a range of 50 mg to 500 mg including 250 mg, Pink Himalayan Salt in a range of 10 mg to 500 mg including 200 mg, Mg of Caffeine Anhydrous in a range of 10 mg to 200 mg including 150 mg, Black Pepper Extract in a range of 0.5 mg to 30 mg including 5 mg.

Further provided herein is a delivery platform for the exercise supporting nutritional supplement. In one or more embodiments the delivery platform comprises at least one of a liquid, a solution, a suspension, a tablet, a powder, a cream, a mist, a patch, an atomized vapor, an aerosol, a soft gelatin capsule, a hard gelatin capsule, a gel, a confectionary, a shake, a bar, a supplemented food, or other avenue of delivery.

Also provided herein is a modified formulation for an exercise supporting nutritional supplement. In some embodiments the formulation comprises Agmatine Sulfate and Betaine Anhydrous. The formulation may further comprise at least one of Choline (as Choline Bitartrate), Citrulline, Creatine Monohydrate, Beta Alanine of L-Tyrosine, Choline Bitartrate, or Bovine Collagen. The formulation sometimes further comprises at least one of Caffeine Anhydrous, Pink Himalayan Salt, or Black Pepper Extract.

In one or more embodiments the formulation comprises Choline (as Choline Bitartrate), Citrulline, Creatine Monohydrate, Beta Alanine, L-Tyrosine, Choline Bitartrate, Bovine Collagen, Caffeine Anhydrous, Pink Himalayan Salt, and Black Pepper Extract.

In certain embodiments the formulation comprises Choline (as Choline Bitartrate) in a range of from 500 mg to 300 mg including 166 mg, Citrulline in a range of from 1000 mg to 8000 mg including 6000 mg, Creatine Monohydrate in a range of 1000 mg to 10,000 mg including 5000 mg, Beta Alanine in a range of 1000 mg to 5000 mg including 3200 mg, Agmatine Sulfate in a range of 500 mg to 4000 mg including 1250 mg, Betaine Anhydrous in a range of 500 mg to 3000 mg including 1250 mg, L-Tyrosine in a range of 500 mg to 3000 mg including 1000 mg, Choline Bitartrate in a range of 100 mg to 1000 mg including 500 mg, Bovine Collagen in a range of 100 mg to 1000 mg including 500 mg, Caffeine Anhydrous in a range of 50 mg to 500 mg including 250 mg, Pink Himalayan Salt in a range of 10 mg to 300 mg including 100 mg, and Black Pepper Extract in a range of 0.5 mg to 20 mg including 5 mg.

Also provided herein is a delivery platform for the modified exercise supporting nutritional supplement herein. In one or more embodiments the delivery platform comprises at least one of a liquid, a solution, a suspension, a tablet, a powder, a cream, a mist, a patch, an atomized vapor, an aerosol, a soft gelatin capsule, a hard gelatin capsule, a gel, a confectionary, a shake, a bar, or a supplemented food or other avenue of delivery.

Further provided herein is a method for an exercise supporting nutritional supplement. An embodiment of the method comprises providing the exercise supporting nutritional supplement herein, ingesting or applying the nutritional supplement, and exercising. In certain embodiments the method comprises monitoring in-exercise strength and energy and ingesting or applying the exercise supporting nutritional supplement at a one or more interval during exercise. The method sometimes comprises ingesting or applying the exercise supporting nutritional supplement following exercise. The method may further comprise hydrating at an interval during exercise and/or following exercise.

Also provided herein is a system for an exercise supporting nutritional supplement. In some embodiments the system comprises the exercise supporting nutritional supplement herein and a delivery platform for the exercise supporting nutritional supplement. The system sometimes comprises at least one of a hard copy, a digital copy, or a digital Application comprising one or more of an instruction set, an exercise example, or an exercise/progress tracking module.

Reference throughout this specification to components or similar language does not imply that all the components that may be included in the present formulation should be or are in any single embodiment of the formulation. Rather, language referring to the components is understood to mean that a specific component or ingredient described in connection with an embodiment is included in at least one embodiment of the present formulation. Thus, discussion of the components or ingredients, and similar language, throughout this specification may, but does not necessarily, refer to the same embodiment.

Furthermore, the described components or ingredients of the formulation herein, with their associated features and characteristics, may be combined in any suitable manner in one or more embodiments. One skilled in the relevant art will recognize that the formulation can be created without one or more of the specific constituents or ingredients of a particular embodiment. In other instances, additional features and characteristics may be recognized in certain embodiments that may not be present in all embodiments of the formulation.

These features and characteristics of the present formulation will become more fully apparent from the following description and appended claims or may be learned by the practice of the formulation as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1A depicts an embodiment of a nutritional supplement packaged for use in accordance with the present disclosure;

FIG. 1B depicts an embodiment of a nutritional supplement ingredients list in accordance with the present disclosure;

FIG. 2A depicts an embodiment of a nutritional supplement packaged for use in accordance with the present disclosure;

FIG. 2B depicts an embodiment of a nutritional supplement ingredients list in accordance with the present disclosure;

FIG. 3 depicts a method for an exercise supporting nutritional supplement in accordance with the present disclosure; and

FIG. 4 depicts an embodiment of a system for an exercise supporting nutritional supplement in accordance with the present disclosure.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described components, ingredients, features, or characteristics of the formulation may be combined in any suitable manner in one or more embodiments. In the following description, numerous specific details are provided. One skilled in the relevant art will recognize, however, that the formulation may be created without one or more of the specific details, or with other methods, components, ingredients, materials, and so forth. In other instances, components, materials, or methods that are known in the art are not shown or described in detail to avoid obscuring aspects of the invention.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

In various embodiments, the formulation herein comprises one or more of L-Citrulline, β Alanine, Creatine monohydrate, L-Tyrosine, Bovine Collagen, Pink Himalayan Salt, Caffeine Anhydrous, Black Pepper Extract, Agmatine Sulfate, Betaine Anhydrous, Choline Bitartrate, and Allulose.

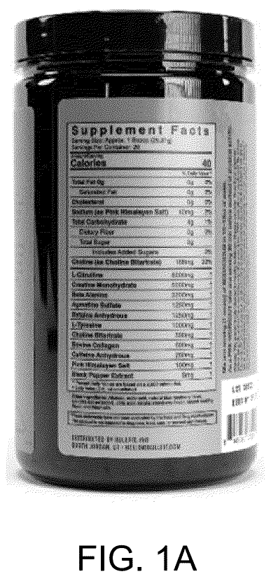

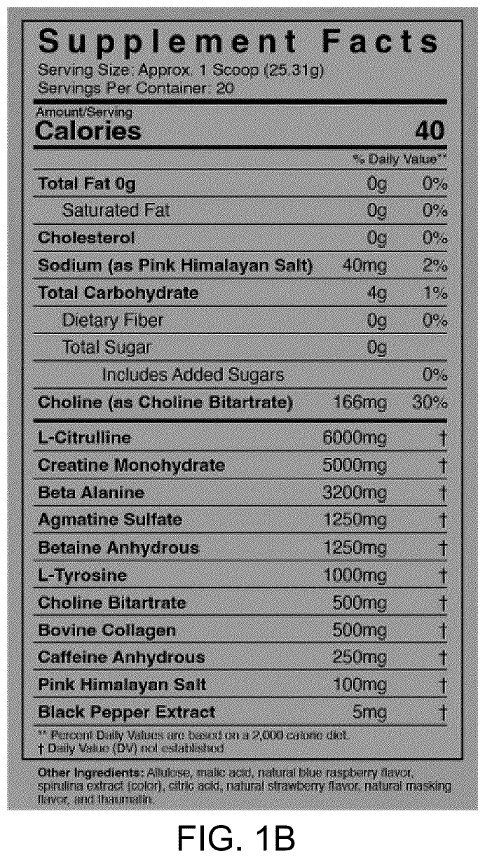

FIG. 1A depicts a bottle of an embodiment of the formulation comprising 166 mg of Choline (as Choline Bitartrate), 4000 mg of Citrulline, 1600 of Beta Alanine, 1000 mg of Creatine Monohydrate, 750 mg of L-Tyrosine, 500 mg of Bovine Collagen, 250 mg of Choline Bitartrate, 200 mg of Pink Himalayan Salt, 150 Mg of Caffeine Anhydrous, and 5 mg of Black Pepper Extract;

FIG. 1B depicts a label from a bottle of the formulation comprising 166 mg of Choline (as Choline Bitartrate), 4000 mg of Citrulline, 1600 of Beta Alanine, 1000 mg of Creatine Monohydrate, 750 mg of L-Tyrosine, 500 mg of Bovine Collagen, 250 mg of Choline Bitartrate, 200 mg of Pink Himalayan Salt, 150 Mg of Caffeine Anhydrous, and 5 mg of Black Pepper Extract;

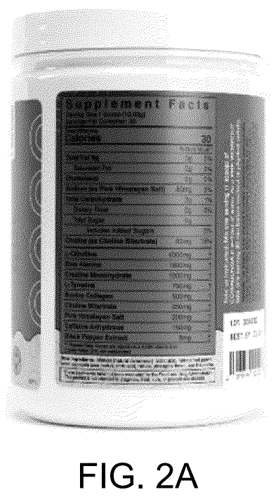

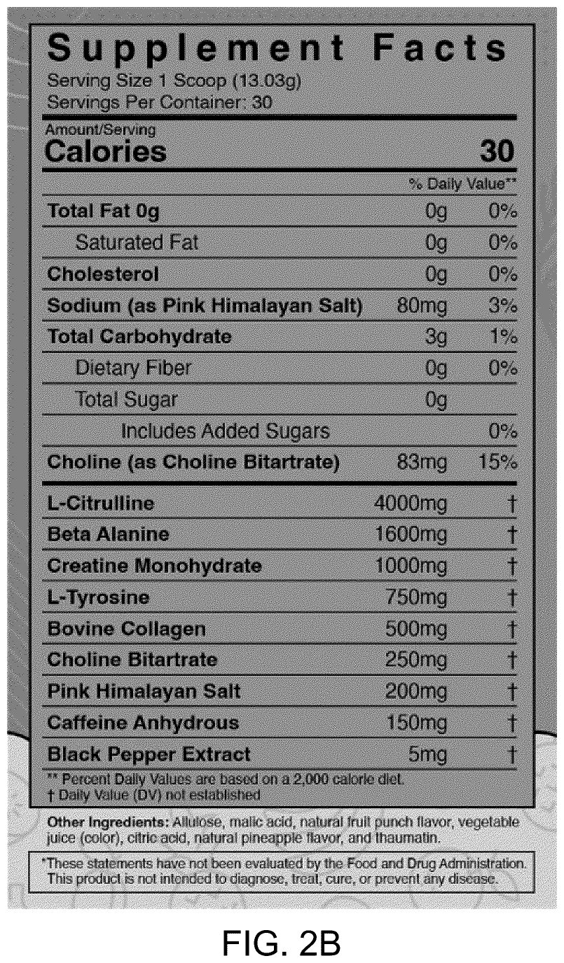

FIG. 2A depicts a bottle of an embodiment of the formulation comprising 166 mg of Choline (as Choline Bitartrate), 6000 mg of Citrulline, 5000 mg of Creatine Monohydrate, 3200 mg of Beta Alanine, 1250 mg of Agmatine Sulfate, 1250 mg of Betaine Anhydrous, 1000 mg of L-Tyrosine, 500 mg of Choline Bitartrate, 500 mg of Bovine Collagen, 250 Mg of Caffeine Anhydrous, 100 mg of Pink Himalayan Salt, and 5 mg of Black Pepper Extract.

FIG. 2B depicts a label from a bottle of an embodiment of the formulation comprising 166 mg of Choline (as Choline Bitartrate), 6000 mg of Citrulline, 5000 mg of Creatine Monohydrate, 3200 mg of Beta Alanine, 1250 mg of Agmatine Sulfate, 1250 mg of Betaine Anhydrous, 1000 mg of L-Tyrosine, 500 mg of Choline Bitartrate, 500 mg of Bovine Collagen, 250 Mg of Caffeine Anhydrous, 100 mg of Pink Himalayan Salt, and 5 mg of Black Pepper Extract.

In some embodiments the formulation is sweetened with allulose. The formulation sometimes comprises natural flavors including, but not limited to, natural fruit punch, natural pineapple, natural blue raspberry, and natural strawberry. Vegetable juice may be included for color. Certain embodiments of the formulation may comprise alternative ranges of the various components.

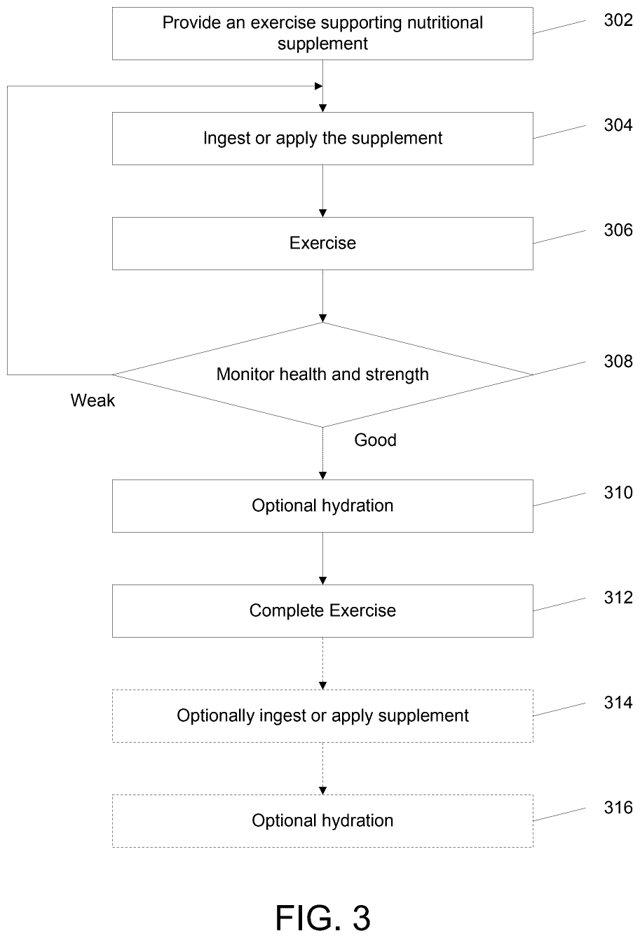

FIG. 3 is a method flow chart depicting an embodiment of a method for an exercise supporting nutritional supplement. In one embodiment, the method provides 302 the exercise supporting nutritional supplement herein, ingests or applies 304 the nutritional supplement, and exercises 306. In certain embodiments, the method monitors 308 energy and strength. If weak, the method may loop back to ingest or apply 304 the nutritional supplement. If good, the method may proceed to optional hydration 310, and complete exercise 312. The method sometimes optionally ingests or applies supplement 314 and optionally hydrate 316.

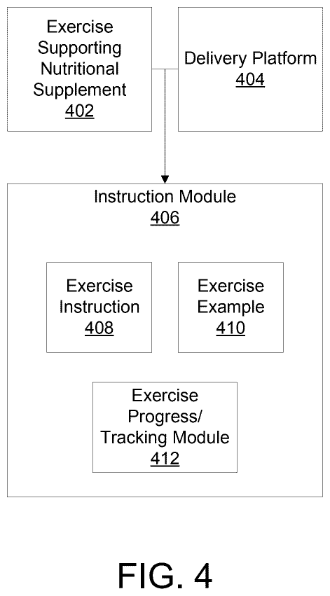

FIG. 4 is a diagram depicting a system 400 for an exercise supporting nutritional supplement. In some embodiments, the system 400 includes the exercise supporting nutritional supplement 402 and a delivery platform 404 for the exercise supporting nutritional supplement 402. In one embodiment, the system 400 sometimes includes at least one of a hard copy, a digital copy, or a digital application/program that includes an instruction module 406. The instruction module 406 may include one or more instructions for use of the exercise supporting nutritional supplement 408, an exercise example 410, and/or an exercise/progress tracking module 412.

In some embodiments the instruction module 406 is a hard copy and may comprise text, charts, graphs, and other illustrative materials. These sometimes explain how to use the exercise supporting nutritional supplement, include example exercises, and provide a graph, chart, or other format for tracking exercise and progress. This information may also be presented in digital form, including as a smart phone application/program, and may be interactive.

Subjects receiving the formulation disclosed herein, in one embodiment, may exhibit significantly increased exercise performance, ability to complete more repetitions, faster recovery, and elevated mood with no post recovery “crash.” Specific benefits are outlined in the examples below, and may include:
a boost in cellular energy, muscle strength, and performance, as well as cognitive benefits and some protective function in case of head trauma;
reduction of blood pressure, expansion of blood vessels, increase of beta-endorphin release (mood enhancement), enhancement of insulin sensitivity, a boost in cognitive function, and inhibition of oxidative stress in neurons;
support for intracellular methylation reactions and cellular antioxidant defense, important processes during exercise and in recovery, facilitation of increased squat, bench press, and other activities;
support for repair of joints and even liver tissue, promoting improved recovery;
preventing a decline in cognitive function in response to physical stress;
support for clear thinking and ability to multitask;
minimizing workout related stomach issues; and
increase in energy and some mood enhancement.

### EXAMPLES

### Example 1: Biological Effects

The components of the formulation may induce specific biological effects. Citrulline may enhance blood flow to the heart and benefit performance and recovery. Creatine Monohydrate may boost cellular energy, muscle strength, and performance, as well as conferring cognitive benefits and be protective in case of head trauma. Beta Alanine is an extensively researched performance enhancing supplement with a strong safety record.

### Example 2: Nitric Oxide Synthesis

Like L-Arginine and L-Citrulline, Agmatine Sulfate is a nitric oxide (NO) booster. As a metabolite of L-Arginine, Agmatine has the vasodilating properties useful in a pre-workout “pump enhancer.” Research suggests that agmatine works primarily by activating endothelial nitric oxide synthase (eNOS), imidazoline receptors, and alpha(2)-adrenergic receptors, all of which modulate nitric oxide synthesis.

These mechanisms appear to govern the various benefits of agmatine supplementation, including reducing blood pressure, expanding blood vessels, increasing beta-endorphin release (mood enhancement), enhancing insulin sensitivity, boosting cognitive function, and inhibiting oxidative stress in neurons.

### Example 3: Methyl Donor and Methionine Homeostasis

Betaine Anhydrous (trimethylglycine), is a naturally occurring and crucial methyl donor for restoring methionine homeostasis in cells. Plasma and tissue sulfur amino acid (SAA) availability are crucial for intracellular methylation reactions and cellular antioxidant defense, which are important processes during exercise and in recovery. Studies have linked Betaine to enhanced power output in athletes, notably in terms of anaerobic strength performance. Athletes supplementing with Betaine increased their squat, bench press, and other activities.

### Example 4: Betaine and Homocysteine

Betaine is synergistic with creatine in preventing the production of homocysteine. Betaine enhances the repair of joints and even liver tissue, supporting improved recovery. High levels of homocysteine can damage the lining in artery walls, and cause blockages in blood vessels, potentially leading to problems like a heart attack or stroke.

### Example 5: L-Tyrosine

L-Tyrosine is the precursor of the catecholamines. Alterations in the availability of L-tyrosine to the brain can influence the synthesis of both dopamine and norepinephrine at least in experimental animals. The main effects of L-tyrosine that have been reported are acute effects in preventing a decline in cognitive function in response to physical stress. In one study, L-tyrosine was given at a dosage of 2 g per day for 5 days during a demanding military combat training course and improved various aspects of cognitive function relative to placebo. Furthermore, supplementing with L-Tyrosine does not build a tolerance as does ingestion of L-Dopamine.

### Example 6: Choline Bitartrate and Acetylcholine

Choline Bitartrate is necessary for the synthesis of acetylcholine, an important neurotransmitter. This component is related to B vitamins and is involved in memory, muscle movement, regulating heartbeat and other basic functions. Observation suggests that Choline Bitartrate supplementation supports clear thinking and ability to multitask.

### Example 7: Other Benefits

Bovine collagen supplies amino acids and supports a healthy gut while minimizing workout related stomach issues. Caffeine Anhydrous, is a pure form of caffeine and contributes energy and some mood enhancement. Pink Himalayan salt contributes trace elements, electrolytes, and hydration benefits. Black pepper assists with the absorption of certain components.

The present formulation may be embodied in other specific forms without departing from its spirit or essential characteristics. The described embodiments are to be considered in all respects only as illustrative and not restrictive. The scope of the formulation is, therefore, indicated by the appended claims rather than by the foregoing description. All changes which come within the meaning and range of equivalency of the claims are to be embraced within their scope.

What is claimed is:

1. A formulation for an exercise supporting nutritional supplement, the formulation comprising:
L-Citrulline;
Agmatine Sulfate; and
Betaine Anhydrous.

2. The formulation of claim 1, further comprising at least one of β Alanine, Creatine monohydrate, or L-Tyrosine.

3. The formulation of claim 2, further comprising at least one of Bovine Collagen or Pink Himalayan Salt.

4. The formulation of claim 3, further comprising at least one of Caffeine Anhydrous, Black Pepper Extract, Choline Bitartrate, or Allulose.

5. The formulation of claim 1, further comprising L-Citrulline, β Alanine, Creatine monohydrate, L-Tyrosine, Bovine Collagen, Pink Himalayan Salt, Caffeine Anhydrous, Black Pepper Extract, Choline Bitartrate, and Allulose.

6. The formulation of claim 5, further comprising one or more of Choline (as Choline Bitartrate) in a range of 50 mg to 200 mg including 166 mg, Citrulline in a range of 1000 mg to 5000 mg including 4000 mg, Beta Alanine in a range of 500 mg to 3000 mg including 1600 mg, Creatine Monohydrate in a range of 100 mg to 3000 mg including 1000 mg, L-Tyrosine in a range of 300 mg to 1500 mg including 750 mg, Bovine Collagen in a range of 100 mg to 1000 mg including 500 mg, Choline Bitartrate in a range of 50 mg to 500 mg including 250 mg, Pink Himalayan Salt in a range of 10 mg to 500 mg including 200 mg, Caffeine Anhydrous in a range of 10 mg to 200 mg including 150 mg, Black Pepper Extract in a range of 0.5 mg to 30 mg including 5 mg.

7. A formulation for an exercise supporting nutritional supplement, the formulation comprising:
Agmatine Sulfate; and
Betaine Anhydrous.

8. The formulation of claim 7, further comprising at least one of Choline (as Choline Bitartrate), Citrulline, Creatine Monohydrate, or Beta Alanine.

9. The formulation of claim 8, further comprising at least one of L-Tyrosine, Choline Bitartrate, 500 mg or Bovine Collagen.

10. The formulation of claim 9, further comprising at least one of Caffeine Anhydrous, Pink Himalayan Salt, or Black Pepper Extract.

11. The formulation of claim 7, further comprising Choline (as Choline Bitartrate), Citrulline, Creatine Monohydrate, Beta Alanine, L-Tyrosine, Choline Bitartrate, Bovine Collagen, Caffeine Anhydrous, Pink Himalayan Salt, and Black Pepper Extract.

12. The formulation of claim 11, further comprising Agmatine Sulfate in a range of 500 mg to 4000 mg including 1250 mg, Betaine Anhydrous in a range of 500 mg to 3000 mg including 1250 mg, Choline (as Choline Bitartrate) in a range of from 500 mg to 300 mg including 166 mg, Citrulline in a range of from 1000 mg to 8000 mg including 6000 mg, Creatine Monohydrate in a range of 1000 mg to 10,000 mg including 5000 mg, Beta Alanine in a range of 1000 mg to 5000 mg including 3200 mg, L-Tyrosine in a range of 500 mg to 3000 mg including 1000 mg, Choline Bitartrate in a range of 100 mg to 1000 mg including 500 mg, Bovine Collagen in a range of 100 mg to 1000 mg including 500 mg, Caffeine Anhydrous in a range of 50 mg to 500 mg including 250 mg, Pink Himalayan Salt in a range of 10 mg to 300 mg including 100 mg, and Black Pepper Extract in a range of 0.5 mg to 20 mg including 5 mg.

13. A method for an exercise supporting nutritional supplement, the method comprising:
providing the exercise supporting nutritional supplement;
ingesting or applying the exercise supporting nutritional supplement; and
exercising.

14. The method of claim 13, further comprising monitoring energy and strength and providing the exercise supporting nutritional supplement at a one or more interval during exercise.

15. The method of claim 14, further comprising providing the exercise supporting nutritional supplement following exercise.

16. The method of claim 15, further comprising hydrating at an interval during exercise and/or following exercise.

17. The method of claim 13, wherein the exercise supporting nutritional supplement is ingested or applied via a delivery platform, the delivery platform comprising at least one of a liquid, solution, a suspension, a tablet, a powder, a cream, a mist, a patch, an atomized vapor, an aerosol, a soft gelatin capsule, a hard gelatin capsule, a gel, a confectionary, a shake, a bar, or a supplemented food.

18. A system for an exercise supporting nutritional supplement, the system comprising:
the exercise supporting nutritional supplement; and
a delivery platform for the exercise supporting nutritional supplement.

19. The system of claim 18, further comprising an instruction module comprising at least one of a hard copy, a digital copy, or a digital application comprising one or more of an instruction for use of the exercise supporting nutritional supplement, an exercise example, or an exercise/progress tracking module.

20. The system of claim 18, wherein the delivery platform comprises at least one of a liquid, solution, a suspension, a tablet, a powder, a cream, a mist, a patch, an atomized vapor, an aerosol, a soft gelatin capsule, a hard gelatin capsule, a gel, a confectionary, a shake, a bar, or a supplemented food.
